(19) United States
(12) Patent Application Publication
(10) Pub. No.: US 2007/0277891 A1
(43) Pub. Date: Dec. 6, 2007

(54) COMBINATION FAUCET PROTECTOR AND DIVERTER

(75) Inventor: Gail B. Frankel, Dallas, TX (US)

Correspondence Address: HAYNES AND BOONE, LLP, 901 MAIN STREET, SUITE 3100, DALLAS, TX, 75202, US

(73) Assignee: Gail B. Frankel, Dallas, TX (US)

(21) Appl. No.: 11/538,887

(22) Filed: Oct. 5, 2006

Related U.S. Application Data
(60) Provisional application No. 60/724,187, filed on Oct. 6, 2005.

(51) Int. Cl. B67D 5/37

(52) U.S. Cl. 137/801; 137/625

(57) ABSTRACT

Methods and apparatus for diverting faucet fluid flow. One embodiment of such apparatus includes a first spout, a second spout, means for interfacing the first and second spouts to a faucet, and means for diverting fluid flow from the faucet to a selected one of the first and second spouts.

### CROSS-REFERENCE TO PRIORITY AND RELATED APPLICATIONS

This application claims the benefit of commonly assigned U.S. Provisional Patent Application 60/724,187, entitled, “COMBINATION FAUCET PROTECTOR AND DIVERTER,” filed on Oct. 6, 2005, the entirety of which is hereby incorporated by reference herein.

This application is also related to U.S. Design Pat. No. D326,312, issued May 19, 1992, entitled, “COMBINATION SPOUT COVER AND LIQUID SOAP DISPENSER,” commonly assigned herewith.

### BRIEF DESCRIPTION OF THE DRAWINGS

Aspects of the present disclosure are best understood from the following detailed description when read with the accompanying FIGS. 1-12. In accordance with industry practice, various features may not be drawn to scale, such that dimensions of various features may be arbitrarily increased or reduced for clarity.

FIG. 1 is a perspective view of at least a portion of one embodiment of apparatus according to aspects of the present disclosure.

FIG. 2 is a front view of at least a portion of the apparatus shown in FIG. 1.

FIG. 3 is a side view of at least a portion of the apparatus shown in FIG. 1.

FIG. 4 is a rear view of at least a portion of the apparatus shown in FIG. 1.

FIG. 5 is a top view of at least a portion of the apparatus shown in FIG. 1.

FIG. 6 is a bottom view of at least a portion of the apparatus shown in FIG. 1.

FIG. 7 is a sectional view of at least a portion of the apparatus shown in FIG. 1.

FIG. 8 is a sectional view of at least a portion of an embodiment of apparatus according to aspects of the present disclosure.

FIG. 9 is a sectional view of at least a portion of an embodiment of apparatus according to aspects of the present disclosure.

FIG. 10 is a schematic view of at least a portion of an embodiment of apparatus according to aspects of the present disclosure.

FIGS. 11 and 12 are schematic views of different orientations of at least a portion of an embodiment of apparatus according to aspects of the present disclosure.

### DETAILED DESCRIPTION

It is to be understood that the present disclosure provides different embodiments, or examples. Specific examples of components and arrangements are described herein to simplify the aspects of the present disclosure. Of course, these are merely examples, and are not intended to be limiting to the scope of the present disclosure.

In addition, the present disclosure may repeat reference numerals and/or letters in various figures and/or examples, such as in the following description. However, this repetition may be for the purpose of simplicity and clarity, and does not in itself dictate a relationship between the various embodiments and/or configurations discussed.

Aspects of the present disclosure relate to embodiments of faucet apparatus which may function as a protector and/or a diverter. For example, the apparatus may be configured to fit securely over a faucet to protect young children from the hard edges and/or hot surfaces of the faucet. The apparatus may also include a spray nozzle, possibly at an end of a hose, such that water from the faucet may be directed in a more convenient manner, for example. In some embodiments, the apparatus forms or includes a protective cover having a shape of a character or an animal, such as may be useful in the entertainment or appeasement of a young person during bathing and/or other personal hygiene activities. For example, one such embodiment provides the apparatus in the shape of an elephant, wherein the elephant's trunk is a functional hose with a sprayer at its end.

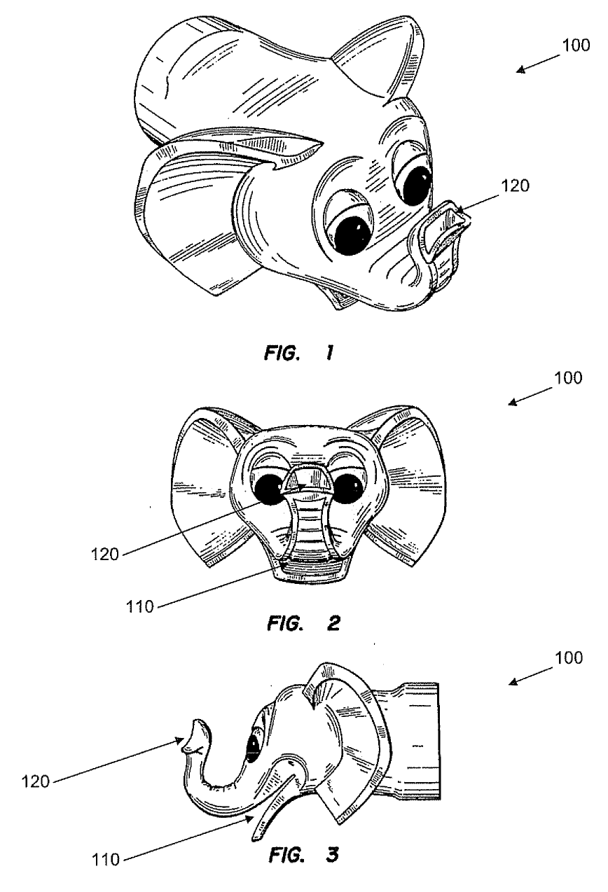

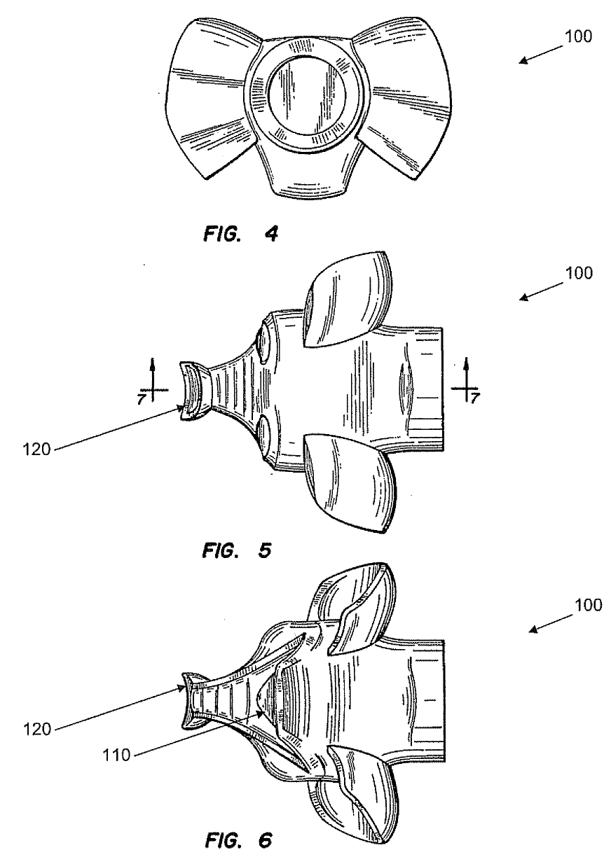

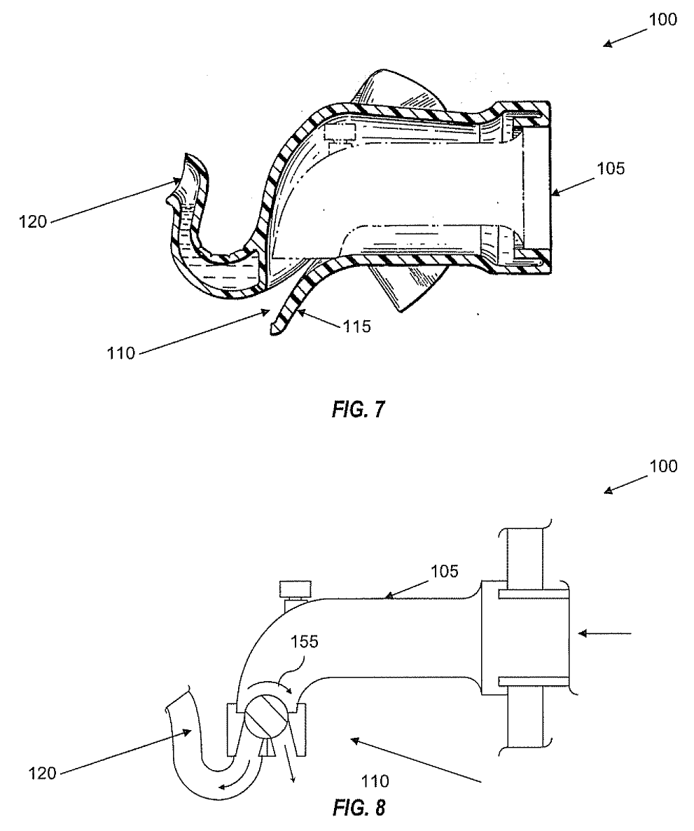

Referring to FIGS. 1-7, collectively, illustrated are various views of at least a portion of one embodiment of an apparatus 100 according to aspects of the present disclosure. In the illustrated embodiment, the apparatus 100 may be an adapter couplable to a water faucet 105 to provide selectable control of water flow from the faucet 105. In other embodiments, the apparatus 100 may include such an adapter or resemble one or more aspects of such an adapter. The water faucet 105 may be a standard or non-standard bathtub faucet, sink faucet, shower faucet, spigot or other type of water spout/outlet, whether it is a conventional, standard or other type of apparatus.

Aspects of the present disclosure are also applicable or readily adaptable to applications in which the selectable redirection of fluids other than water is desired, including palatable fluids, as well as to materials other than fluids, such as air and other gases, or solids of relatively small particle size. However, for the sake of simplicity, embodiments explicitly described herein may generally refer to the flow of water, possibly without mention of other flowing materials. Nonetheless, such convention is not limiting to the scope of the present disclosure, such that even those aspects described herein in the context of water flow control may be applicable or readily adaptable to controlling flow of materials other than water. Moreover, aspects of the present disclosure are also applicable or readily adaptable to applications in which the redirection may be selected from between more than two flow-paths, including embodiments in which all flow from the faucet 105 is substantially stopped.

The illustrated embodiment of the apparatus 100 includes a first spout 110 and a second spout 120. In embodiments in which at least a portion of the apparatus 100 resembles a character or animal, at least one of the first and second spouts 110, 120 may resemble or otherwise correspond to the mouth, nose, trunk, horn, tail or other feature of the character or animal. For example, in the illustrated embodiment in which the apparatus 100 substantially resembles an elephant head, the first spout 110 corresponds to the mouth of the elephant, and the second spout 120 corresponds to the trunk of the elephant. In other embodiments in which at least a portion of the apparatus 100 substantially resembles a character or animal or is otherwise “functionally ornamental,” other features of the character or animal may have functions other than as a water spout. For example, in an embodiment which may be similar to the illustrated embodiment, the ears or eyes of the elephant may correspond to the controls for the temperature and/or flow rate of the water delivered to one or both of the first and second spouts 110, 120.

As another example, the ears or eyes of the character or animal could provide a visual indicator of the temperature of the water being delivered to one or both of the spouts 110, 120. For example, such an indicator may have a first color (e.g., blue) if the water is cool and a second color (e.g., red) if the water is hot. Another embodiment of such an indicator may emit an audible sound to indicate that the water has been turned on, or that the water temperature is safe or unsafe. This and/or other sounds may also be selectively emitted, such as for entertainment purpose, possibly by depressing a button on the apparatus, wherein the button may also correspond to a feature of the character or animal.

The first and second spouts 110, 120 may be configured such that water may flow only through one of the spouts 110, 120 when the apparatus 100 is configured in a first orientation, and the other of the spouts 110, 120 when the apparatus 100 is configured in a second orientation, but where water cannot flow through both the first and second spouts 110, 120 simultaneously. However, in other embodiments, the apparatus 100 may be configured for dual-directional flow such that water may flow through the first and second spouts 110, 120 simultaneously.

In one embodiment, the spout 110 may be a default spout, such that water may always flow through only the spout 110 in the absence of any action by the user. For example, the spout 110 may include a hinged or otherwise deflectable portion 115 configured to pivot or otherwise deflect between open and closed orientations, where the closed orientation of the hinged portion 115 may be a default or passive orientation. Consequently, when the user desires to divert the water flow from the first spout 110 to the second spout 120, the user may press the hinged portion 115 against the faucet 105, thereby preventing water flow through the spout 110 and, consequently, diverting water flow through the second spout 120.

Similar functionality may also be provided by less complex configurations, such as where no hinged portion 115 exists and the user merely blocks the spout 110 with the user's hand or finger or another object, such as a removable cap or merely a washcloth or other loose item with the user's reach. However, similar functionality may also be provided by other configurations.

For example, the apparatus 100 may include a flow control valve, including those which do not require continually pressing against the apparatus 100 to continue diverting water flow. For example, as in the embodiment illustrated in FIG. 8, a ball or barrel valve 150 may be configured to rotate from a first position shown in FIG. 8 to or towards a second position, as indicated by arrow 155. Consequently, the flow may be selectably diverted to one of the spouts 110, 120. Similar flow control valves may also be employed where the user may select water flow through both spouts 110, 120.

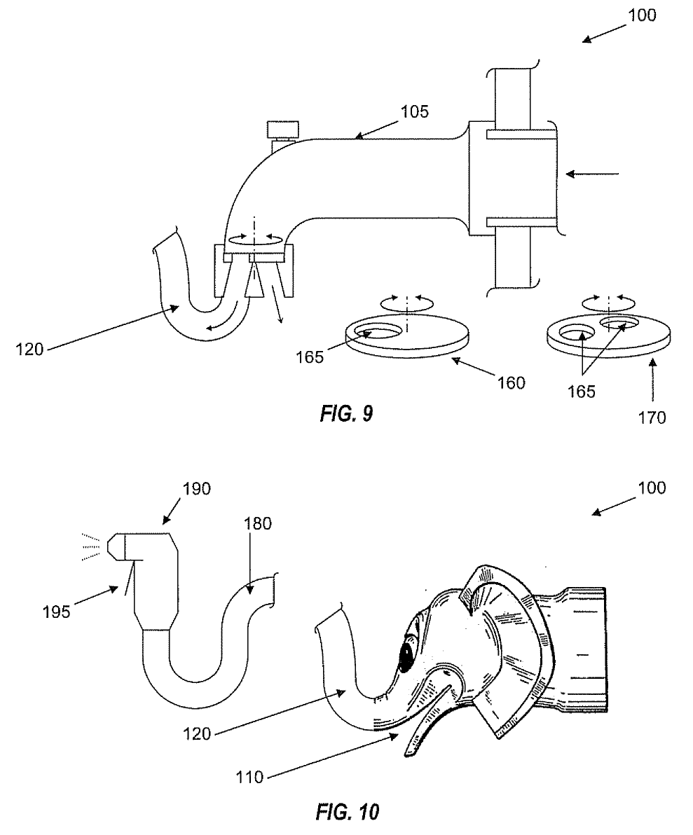

FIG. 9 depicts a similar embodiment in which a rotatable disk 160 is configured to divert water flow between the first and second spouts 110, 120 depending on alignment of an aperture 165 in the disk 160 with which of the spouts 110, 120. Another embodiment of the disk 160, designated herein by the reference numeral 170, includes two apertures 165, such that the appropriate rotation of the disk 170 can provide water flow through one or both of the spouts 110, 120 depending on alignment of the apertures 165 with the spouts 110, 120.

There are also various embodiments of the spout 120 within the scope of the present disclosure. For example, as shown in FIG. 10, a hose 180 and/or a sprayer 190 may be directly or indirectly coupled to the spout 120, perhaps in a detachable manner, or the hose/sprayer may be integral or otherwise substantially permanently secured to the spout 120. The hose 180 may be flexible, such as a rubber, braided, plastic, poly or other material hose or tubing, among other possibilities. In one embodiment, the hose 180 may be retractable into the apparatus 100 or another container. For example, in the embodiment of FIG. 10, part of the elephant's nose may be configured to uncoil, dispense or otherwise extend such that the sprayer 190 is proximate a child sitting near the apparatus 100 (e.g., in a bathtub or sink in which the faucet 100 is installed) and retract back into the apparatus 100 after use.

In one embodiment in which the apparatus 100 includes the hose 180 and sprayer 190, diverting the water flow from the spout 110 to the spout 120 may be controlled by a handle 195 or other actuator portion of the sprayer 190. For example, water may generally flow through the spout 110 unless the handle 195 of the sprayer 190 is depressed, at which time flow may be diverted through the spout 120 and the hose 180, ultimately dispensing through the sprayer 190. In other embodiments, actuating the sprayer 190 may not stop water flow through the spout 110, such that water may flow through both spouts 110, 120 at the same time. The sprayer 190 may also be configurable with removable nozzles and/or include an adjustable nozzle, such as may be employed to control the water pressure and/or spray pattern from the sprayer 190.

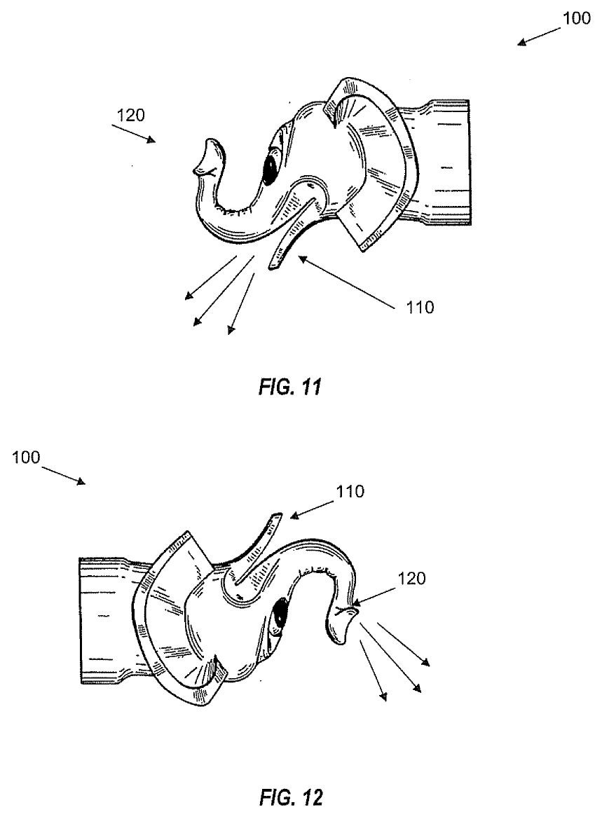

Referring to FIGS. 11 and 12, collectively, illustrated are side views of at least a portion of another embodiment of the apparatus 100 described above. A portion of the apparatus 100 may be rotated relative to the faucet 105 in order to control to which of the spouts 110, 120 water flow is diverted. However, in the embodiment of FIGS. 11 and 12, a more substantial portion of the apparatus 100 may be rotated relative to the faucet 105, thereby diverting water flow between the spouts 110, 120 substantially by relying on fundamentals of gravity and fluid dynamics. For example, the internal passages of the apparatus 100 may be configured such that as in FIG. 11, water may primarily flow through the spout 110 unless the apparatus 100 is rotated to a second orientation such that, as in FIG. 12, water may primarily flow through the spout 120. In the embodiment illustrated in FIG. 12 demonstrating this aspect, the rotation of the apparatus 100 is about 180 degrees. Of course, in other embodiments the rotation may be substantially less, possibly as little as 5 or 10 degrees.

In one or more or all of the embodiments described above or otherwise within the scope of the present disclosure, the apparatus 100 may include an interface configured to couple the apparatus 100 and the faucet 105, possibly in a detachable manner. Such interface may comprise an internal profile of the apparatus 100 configured to cooperate with the external shape of the faucet 105. Alternatively, or additionally, the faucet 105 may include straps, buckles, tab-slot configurations, hook-and-loop (VELCRO) fasteners, snaps, buttons, pins, or combinations thereof, among the myriad mechanical coupling means within the scope of the present disclosure.

In view of the above, it should be readily apparent to those skilled in the pertinent art that the present disclosure introduces, at least in one exemplary embodiment, an apparatus comprising a first spout, a second spout, means for interfacing the first and second spouts to a faucet, and means for diverting fluid flow from the faucet to a selected one of the first and second spouts. The faucet may be selected from the group consisting of a bathtub faucet, a sink faucet, a shower faucet, and a spigot. The apparatus may further comprise a hose and possibly a sprayer, wherein a first end of the hose is coupled to one of the first and second spouts, and wherein the sprayer is coupled to a second end of the hose. The first and second spouts may be integral to a body resembling an elephant head having a mouth opening and a trunk opening, wherein the first spout is fluidicly coupled to the mouth opening, and wherein the second spout is fluidicly coupled to the trunk opening.

The present disclosure also introduces a method of operating a fluid diverter apparatus. At least in one exemplary embodiment, the method comprises interfacing a fluid diverter apparatus to a faucet, wherein the fluid diverter apparatus comprises a first spout, a second spout, means for interfacing the first and second spouts to a faucet, and means for diverting fluid flow from the faucet to a selected one of the first and second spouts. The method further comprises diverting fluid flow from the faucet to a selected one of the first and second spouts. In such method, the faucet may be selected from the group consisting of: a bathtub faucet, a sink faucet, a shower faucet, and a spigot. The fluid diverter apparatus may further comprise a hose coupled to one of the first and second spouts, and possibly a sprayer, wherein a first end of the hose is coupled to one of the first and second spouts, wherein the sprayer is coupled to a second end of the hose, and wherein diverting the fluid flow from the faucet to the selected one of the first and second spouts comprises operating the sprayer. The first and second spouts may be integral to a body resembling an elephant head having a mouth opening and a trunk opening, wherein the first spout is fluidicly coupled to the mouth opening, and wherein the second spout is fluidicly coupled to the trunk opening.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions and alterations herein without departing from the spirit and scope of the present disclosure.

What is claimed is:

1. An apparatus, comprising:
a first spout;
a second spout;
means for interfacing the first and second spouts to a faucet; and
means for diverting fluid flow from the faucet to a selected one of the first and second spouts.

2. The apparatus of claim 1 wherein the faucet is selected from the group consisting of:
a bathtub faucet;
a sink faucet;
a shower faucet; and
a spigot.

3. The apparatus of claim 1 further comprising a hose coupled to one of the first and second spouts.

4. The apparatus of claim 1 further comprising a sprayer, wherein a first end of the hose is coupled to one of the first and second spouts, and wherein the sprayer is coupled to a second end of the hose.

5. The apparatus of claim 1 wherein the first and second spouts are integral to a body resembling an elephant head having a mouth opening and a trunk opening, wherein the first spout is fluidicly coupled to the mouth opening, and wherein the second spout is fluidicly coupled to the trunk opening.

6. A method of operating a fluid diverter apparatus, comprising:
interfacing a fluid diverter apparatus to a faucet, wherein the fluid diverter apparatus comprises;
a first spout;
a second spout;
means for interfacing the first and second spouts to a faucet; and
means for diverting fluid flow from the faucet to a selected one of the first and second spouts; and
diverting fluid flow from the faucet to a selected one of the first and second spouts.

7. The method of claim 6 wherein the faucet is selected from the group consisting of:
a bathtub faucet;
a sink faucet;
a shower faucet; and
a spigot.

8. The method of claim 6 wherein the fluid diverter apparatus further comprises a hose coupled to one of the first and second spouts.

9. The method of claim 6 wherein the fluid diverter apparatus further comprises a sprayer, wherein a first end of the hose is coupled to one of the first and second spouts, wherein the sprayer is coupled to a second end of the hose, and wherein diverting the fluid flow from the faucet to the selected one of the first and second spouts comprises operating the sprayer.

10. The method of claim 6 wherein the first and second spouts are integral to a body resembling an elephant head having a mouth opening and a trunk opening, wherein the first spout is fluidicly coupled to the mouth opening, and wherein the second spout is fluidicly coupled to the trunk opening.
